(19) United States
(12) Patent Application Publication
(10) Pub. No.: US 2024/0112519 A1
(43) Pub. Date: Apr. 4, 2024

(54) CONSUMABLE CONSUMING DEVICE AND STORAGE MEDIUM STORING INSTRUCTIONS FOR PERFORMING BILLING CONTROL PROCESS

(71) Applicant: BROTHER KOGYO KABUSHIKI KAISHA, Nagoya (JP)

(72) Inventor: Taichiro KIMOTO, Nagoya (JP)

(73) Assignee: BROTHER KOGYO KABUSHIKI KAISHA, Nagoya (JP)

(21) Appl. No.: 18/475,477

(22) Filed: Sep. 27, 2023

(30) Foreign Application Priority Data
Sep. 30, 2022 (JP) 2022-158504

(51) Int. Cl. G07F 17/26; B41J 2/175

(52) U.S. Cl. CPC G07F 17/266; B41J 2/17566; B41J 2002/17589

(57) ABSTRACT

A consumable consuming device includes a consumable holder and a controller. The controller is switchable between a first state in which no agreement for delivery of a consumable is in effect and a second state in which an agreement for delivery of the consumable is in effect. The controller is configured to perform: a first determination process to determine a first remaining life that is a remaining life of the consumable provided to the consumable holder during a time when no agreement for delivery of the consumable is in effect; a consumption process to perform a prescribed operation while consuming the consumable in the second state; and a billing control process to perform a billing-related process after the first remaining life decreases to a predetermined quantity through execution of the consumption process but does not perform the billing-related process until the first remaining life decreases to the predetermined quantity.

### REFERENCE TO RELATED APPLICATIONS

This application claims priority from Japanese Patent Application No. 2022-158504 filed on Sep. 30, 2022. The entire content of the priority application is incorporated herein by reference.

### BACKGROUND ART

A printer is an example of a consumable consuming device that consumes such consumables as ink, toner, paper, various rollers (e.g., developing rollers, fixing rollers, and conveying rollers), and print heads. The user of a printer may enter an agreement with a printer vendor for the delivery of consumables and may use the printer in accordance with the agreement.

For example, the user of the printer may pay a consideration to enter an agreement that allows the user to use ink free of charge until the number of printed sheets reaches a predetermined number (hereinafter called the contracted number of sheets). Under this agreement, the vendor ships bottles of ink to the user, for example, when the printer runs low on ink. The user is not charged for delivery of the bottles or for the ink itself while the number of printed sheets remains less than or equal to the contracted number of sheets.

There has been conventionally known an image recording device having sub-tanks. Tanks for containing ink can be mounted on the image recording device. In the image recording device, the sub-tank is not replenished with ink from a mounted tank when the mounted tank does not conform with a prescribed condition and is replenished with ink from the mounted tank when the tank conforms with the prescribed condition. If a special tank or a general tank is mounted in the image recording device while the user is under a predetermined agreement or if the general tank is mounted in the image recording device while the user is not under the predetermined agreement, the image recording device determines that the mounted tank conforms to the prescribed condition. On the other hand, if the special tank is mounted in the image recording device while the user is not under the predetermined agreement, the image recording device determines that the mounted tank does not conform to the prescribed condition.

### DESCRIPTION

Below, a printer provided with a tank having an ink inlet port will be considered as an example of the consumable consuming device. In the following description, a state in which an agreement for the delivery of ink is in effect will be called a “contracted state,” and a state in which no agreement for the delivery of ink is in effect will be called a “non-contracted state.” Further, bottles delivered by the printer vendor under a contracted state will be called “contract bottles,” while bottles sold commercially will be called “commercial bottles.” Further, ink originally stored in contract bottles will be called “contract ink,” while ink originally stored in commercial bottles will be called “commercial ink.”

In the non-contracted state, the user purchases commercial bottles and fills the tank with commercial ink from the purchased commercial bottles. In the contracted state, the user receives contract bottles shipped from the printer vendor and fills the tank with contract ink from the received contract bottles. Normally, the printer consumes commercial ink when printing and the like in the non-contracted state and consumes contract ink when printing and the like in the contracted state.

After entering a new agreement for ink delivery, the user may in some cases refill the tank with contract ink from contract bottles, even though some commercial ink remains in the tank. When the user adds contract ink to a tank containing residual commercial ink, the commercial ink and contract ink become mixed in the tank and are no longer distinguishable. If the printer begins the process for billing the user immediately after the agreement is entered in such cases, the user will be charged for printing and other processes using the commercial ink remaining in the tank despite already having paid for this commercial ink, resulting in financial loss equivalent to the purchase price for that amount of residual commercial ink.

In view of the foregoing, it is an object of the present disclosure to provide a technology for suppressing users from incurring billing-related financial loss after the user enters an agreement for the delivery of consumables.

In order to attain the above and other objects, according to one aspect, the present disclosure provides a consumable consuming device including a consumable holder and a controller. The controller is switchable between a first state in which no agreement for delivery of a consumable is in effect and a second state in which an agreement for delivery of the consumable is in effect. The controller is configured to perform a first determination process, a consumption process, and a billing control process. The first determination process is a process to determine a first remaining life. The first remaining life is a remaining life of the consumable that is provided to the consumable holder during a time when no agreement for delivery of the consumable is in effect. The consumption process is a process to perform a prescribed operation while consuming the consumable in the second state. The billing control process is a process in which the controller performs a billing-related process after the first remaining life is decreased to a predetermined quantity through execution of the consumption process but does not perform the billing-related process until the first remaining life is decreased to the predetermined quantity.

According to another aspect, the present disclosure provides a non-transitory computer-readable storage medium storing a set of computer-readable instructions for a consumable consuming device. The consumable consuming device includes a consumable holder and a controller. The controller is switchable between a first state in which no agreement for delivery of the consumable is in effect and a second state in which an agreement for delivery of the consumable is in effect. The set of computer-readable instructions, when executed by the controller, causes the consumable consuming device to perform a first determination process, a consumption process, and a billing control process. The first determination process is a process to determine a first remaining life. The first remaining life is a remaining life of the consumable that is provided to the consumable holder during a time when no agreement for delivery of the consumable is in effect. The consumption process is a process to perform a prescribed operation while consuming the consumable in the second state. The billing control process is a process in which the controller performs a billing-related process after the first remaining life is decreased to a predetermined quantity through execution of the consumption process but does not perform the billing-related process until the first remaining life is decreased to the predetermined quantity.

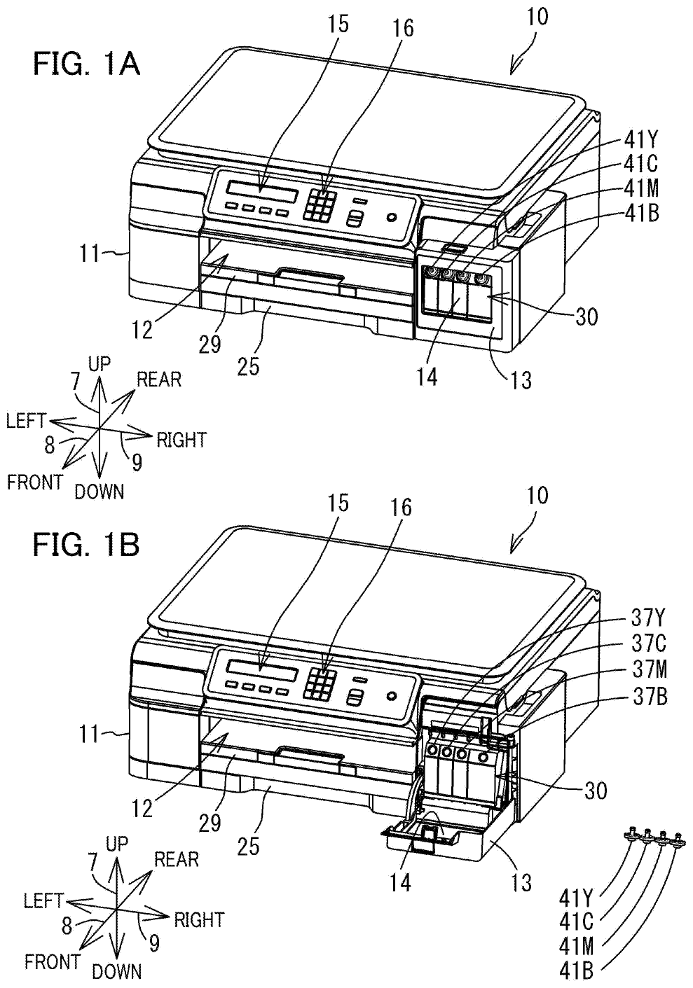

FIG. 1A is a perspective view of the external appearance of a printer 10 when a cover 13 is in a closed state.

FIG. 1B is a perspective view of the external appearance of the printer 10 when the cover 13 is in an open state.

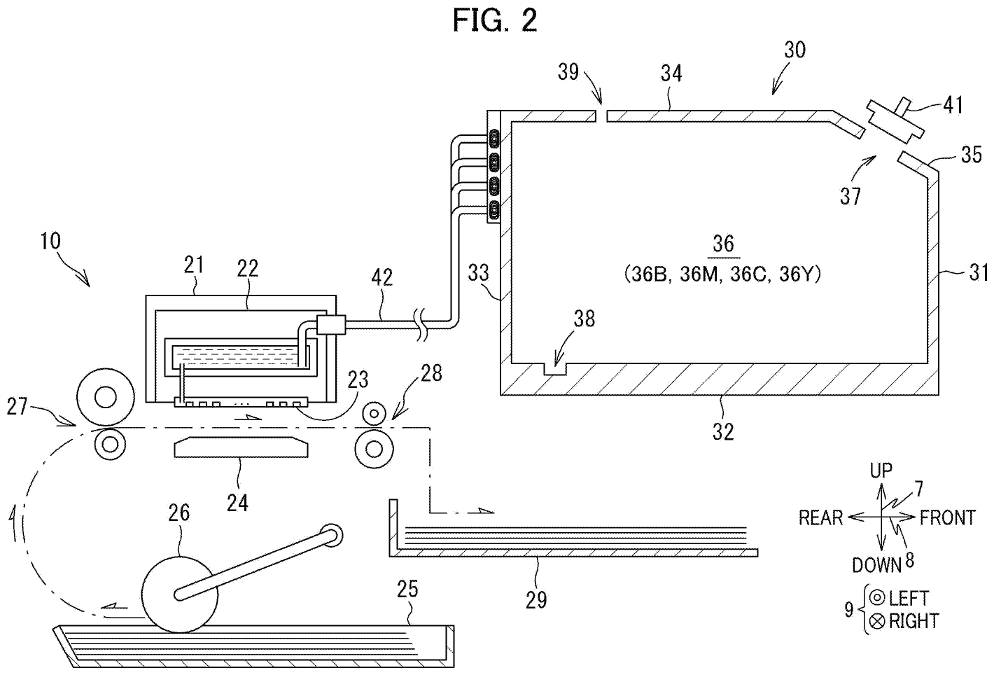

FIG. 2 is a schematic vertical cross-sectional view of the internal structure of the printer 10.

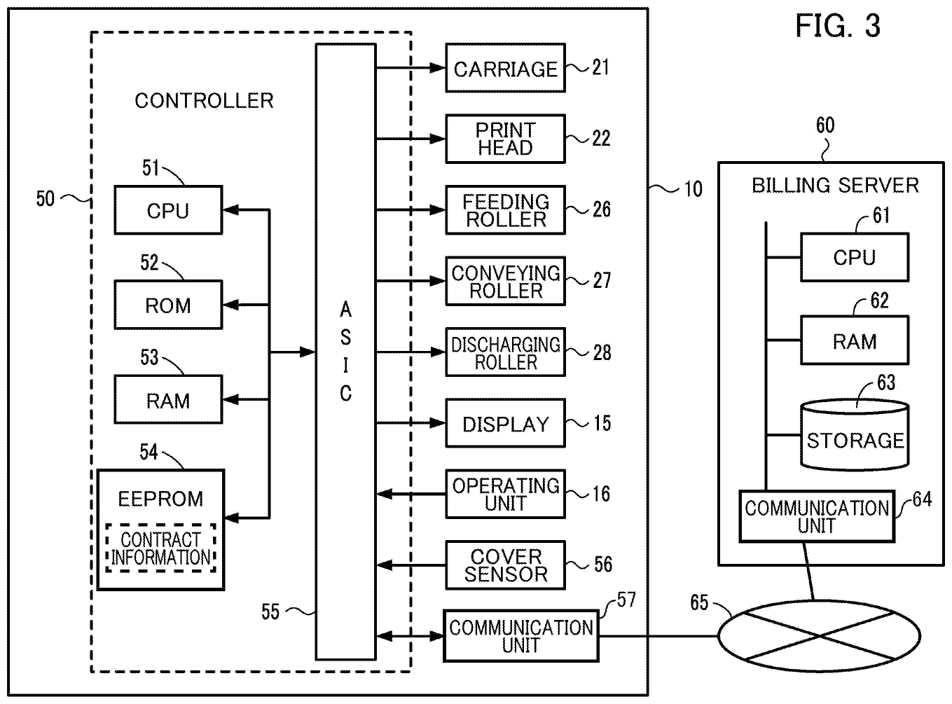

FIG. 3 is block diagrams of the printer 10 and a billing server 60.

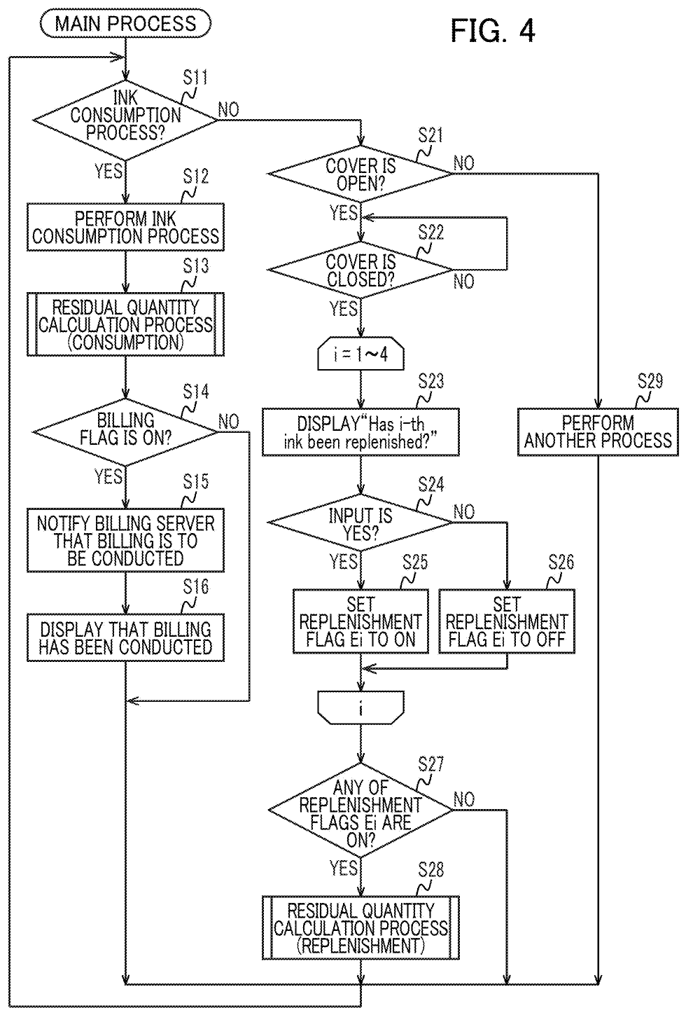

FIG. 4 is a flowchart illustrating steps in a main process.

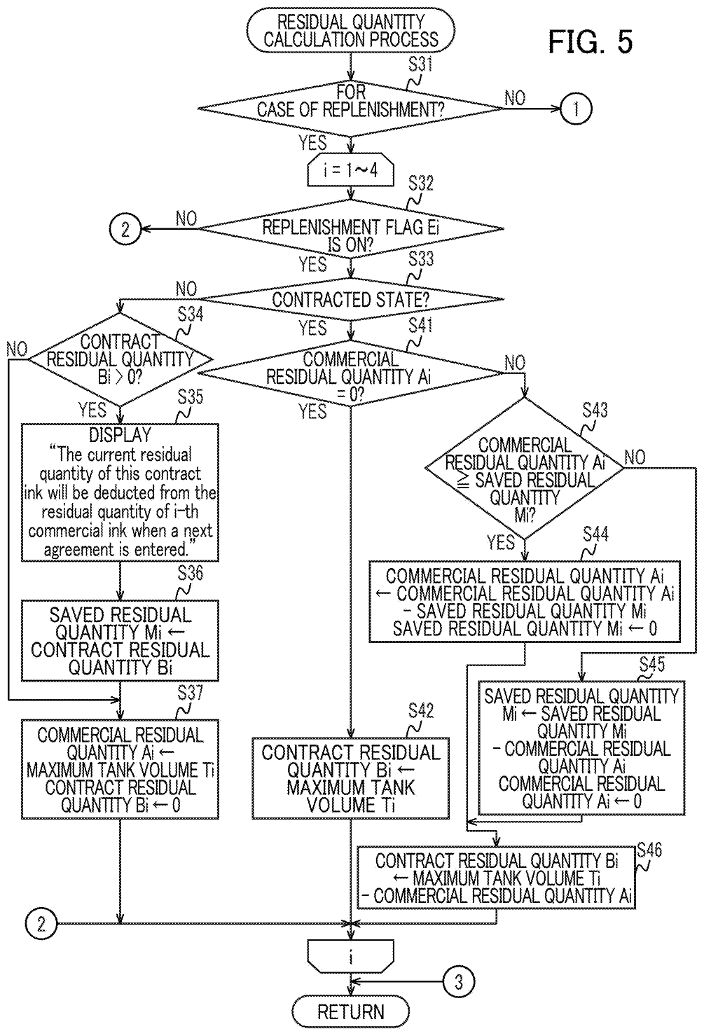

FIG. 5 is a flowchart illustrating steps in a residual quantity calculation process.

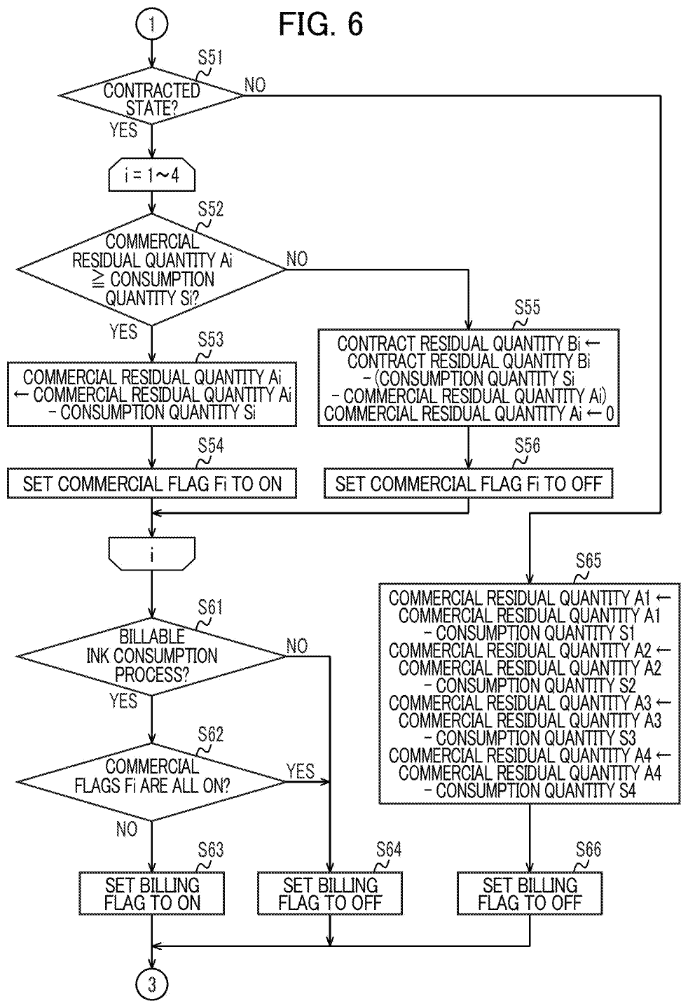

FIG. 6 is a flowchart illustrating the remaining steps in the residual quantity calculation process.

Next, an embodiment of the present disclosure will be described while referring to the accompanying drawings. Note that the embodiment described below is merely an example of the disclosure and may be modified in many ways without departing from the spirit of the disclosure. Further, an up-down direction 7 is defined based on the orientation of a printer 10 when the printer 10 is in an operable state installed on a level surface; a front-rear direction 8 is defined so that the side of the printer 10 in which an opening 12 is located constitutes the front side; and a left-right directions 9 is defined based on the perspective of an observer facing the front side of the printer 10. The up-down direction 7, front-rear direction 8, and left-right direction 9 are mutually orthogonal.

<Overview of the Printer 10>

The printer 10 according to the present embodiment is an example of the consumable consuming device that performs printing and the like while consuming ink (an example of the consumable and the printing agent). The printer 10 records images on sheets according to an inkjet recording method. The printer 10 is provided with a casing 11 that has a general rectangular parallelepiped shape. The printer 10 may be a multifunction peripheral having such functions as a facsimile function, a scan function, and a copy function.

As shown in FIGS. 1 and 2, the printer 10 includes a carriage 21, a print head 22, a platen 24, a feeding tray 25, a feeding roller 26, conveying rollers 27, discharging rollers 28, a discharge tray 29, a tank 30, and tubes 42 in the inside of the printer 10. The print head 22 has a plurality of nozzles 23. The platen 24 opposes the print head 22. The carriage 21, print head 22, platen 24, feeding tray 25, feeding roller 26, conveying rollers 27, and discharging rollers 28 are an example of the printing engine.

The printer 10 drives the feeding roller 26 and conveying rollers 27 to convey sheets supported on the feeding tray 25 to the location of the platen 24. Next, the printer 10 ejects ink, which has been supplied to the print head 22 from the tank 30 via the tubes 42, from the nozzles 23 of the print head 22. The ejected ink lands on a sheet supported on the platen 24, recording an image on the sheet. The printer 10 drives the discharging rollers 28 to discharge the sheet having the image recorded thereon onto the discharge tray 29.

The carriage 21 reciprocates in the left-right direction 9, which crosses the direction in which the conveying rollers 27 convey sheets. The print head 22 is mounted on the carriage 21. While moving the carriage 21 from one side in the left-right direction 9 to the other, the printer 10 ejects ink from the nozzles 23 in the print head 22, thereby recording an image in a partial area of the sheet that opposes the print head 22. Next, the printer 10 controls the conveying rollers 27 to convey the sheet so that the area in which the next image is to be recorded faces the print head 22. By repeatedly and alternately executing these processes, the printer 10 records an image on one sheet.

<Tank 30>

As shown in FIG. 1, the tank 30 is positioned in the right-front portion of the casing 11. The tank 30 is fixed in the printer 10 so as not to be easily removed therefrom. A cover 13 that covers the tank 30 is positioned at the right end portion of the front surface of the casing 11. The cover 13 is supported on the casing 11 so as to be pivotally movable. The cover 13 is configured to be switched between a closed state shown in FIG. 1A and an open state shown in FIG. 1B.

As shown in FIG. 2, the tank 30 has a front wall 31, a bottom wall 32, a rear wall 33, a top wall 34, a sloped wall 35, a right wall (not shown), and a left wall (not shown). The inner space of the tank 30 is defined by these seven walls. Three partitioning walls (not shown) are positioned inside the inner space of the tank 30. The three partitioning walls divide the inner space of the tank 30 into four ink chambers 36. Hereinafter, these four ink chambers will be called ink chambers 36B, 36M, 36C, and 36Y. The ink chambers 36B, 36M, 36C, and 36Y store ink in the respective colors black, magenta, cyan, and yellow. The ink chambers 36B, 36M, 36C, and 36Y may have the same capacity or different capacities.

The tank 30 is formed with inlet ports 37 in the sloped wall 35 for injecting ink into (i.e., for providing ink to) the corresponding ink chambers 36. Specifically, the inlet ports 37 has inlet ports 37B, 37M, 37C, and 37Y for supplying ink into (i.e., for providing ink to) the respective ink chambers 36B, 36M, 36C, and 36Y (see FIG. 1B). The inlet ports 37 penetrate the sloped wall 35 in the thickness direction thereof to provide communication between the ink chambers 36 and the exterior of the tank 30. Note that the inlet ports 37 may be formed in the top wall 34 rather than the sloped wall 35.

A cap 41 is detachably attachable to each inlet port 37. In other words, the tank 30 has caps 41B, 41M, 41C, and 41Y that are detachably attachable to the respective inlet ports 37B, 37M, 37C, and 37Y (see FIG. 1A). When attached to the inlet port 37, the cap 41 closely contacts the peripheral edges of the inlet port 37 to seal the inlet port 37 closed (see FIG. 1A). When the cap 41 is detached from the inlet port 37, on the other hand, the inlet port 37 is open (see FIG. 1B). The caps 41 are attachable to and detachable from the corresponding inlet ports 37 while the cover 13 is in the open state. The user of the printer 10 places the cover 13 in the open state, detaches the caps 41 from the inlet ports 37, and injects (supplies) ink from bottles at hand into the corresponding ink chambers 36 via the inlet ports 37.

An outlet port 38 is formed in the bottom wall 32 of the tank 30 for each ink chamber 36, and an air-communicating port 39 is formed in the top wall 34 of the tank 30 for each ink chamber 36. Ink stored in the ink chamber 36 is supplied to the print head 22 via the corresponding outlet port 38 and tube 42.

The cover 13 has a transparent window 14 (see FIG. 1). Further, at least the front wall 31 of the tank 30 is formed of a transparent material. Therefore, the user can see the residual quantity of ink in each ink chamber 36 via the front wall 31 even when the cover 13 is in the closed state.

Note that the tank 30 is not limited to the configuration in the example described above. Specifically, the number of ink chambers 36 and the colors of ink stored therein are not limited to the above example. For example, the printer 10 may be a monochrome printer including a tank having only one ink chamber storing black ink. Alternatively, the printer 10 may be include a tank having five or more ink chambers storing different colors of ink. The tank 30 is an example of the consumable holder to which the consumable can be provided.

<Controller 50>

As shown in FIG. 3, the printer 10 is also provided with a controller 50. The controller 50 includes a CPU 51, a ROM 52, a RAM 53, an EEPROM 54, and an ASIC 55. The ROM 52 stores programs and the like for the CPU 51 to execute various processes. The RAM 53 is used as a storage area for temporarily storing data, signals, and the like used when the CPU 51 executes the programs or as a work area for data processing. The EEPROM 54 stores information that should be preserved after the power is off. The ROM 52, RAM 53, and EEPROM 54 function as the storage of the controller 50.

The storage may be a computer-readable storage medium. A computer-readable storage medium is a non-transitory medium. In addition to the above examples, non-transitory media may include storage media such as CD-ROM and DVD-ROM. A non-transitory medium is also a tangible medium. On the other hand, while electric signals that convey programs downloaded from a server or the like on the Internet constitute a computer-readable signal medium, which is a type of computer-readable medium, electric signals are not considered non-transitory computer-readable storage media.

The ASIC 55 is connected to the carriage 21, print head 22, feeding roller 26, conveying rollers 27, and discharging rollers 28. By driving a motor (not shown) via the ASIC 55, the controller 50 moves the carriage 21 in the left-right direction 9 and rotates the feeding roller 26, conveying rollers 27, and discharging rollers 28. By outputting drive signals to driving elements of the print head 22 via the ASIC 55, the controller 50 ejects ink from the nozzles 23 in the print head 22. The ASIC 55 outputs a plurality of types of drive signals according to the quantity of ink to be ejected from the nozzles 23.

The ASIC 55 is also connected to a display 15 and an operating unit 16. The display 15 is configured to display messages and the like in a display area in response to instructions from the controller 50. The display 15 is a liquid crystal display or an organic light emitting diode display, for example. The display 15 is an example of the user interface. The operating unit 16 is configured to output signals to the controller 50 based on user operations. For example, the operating unit 16 may include push buttons or touch sensors overlaid on the display 15.

The ASIC 55 is also connected to a cover sensor 56. The cover sensor 56 is configured to output signals to the controller 50 indicating whether the cover 13 is in the closed state or the open state. The cover sensor 56 may be a switch or other mechanical sensor that detects contact and separation of the cover 13 or may be an optical sensor whose light is blocked or transmitted depending on the position of the cover 13.

The ASIC 55 is also connected to a communication unit 57. The communication unit 57 is an interface used to communicate with external devices. By controlling the communication unit 57, the printer 10 exchanges various data with external devices via a communication network 65. The communication network 65 may be a network that includes the Internet or a network that includes telephone lines or leased lines. External devices with which the printer 10 communicates include a billing server 60 that performs a billing process.

<Billing Server 60>

As shown in FIG. 3, the billing server 60 includes a CPU 61, a RAM 62, a storage 63, and a communication unit 64. The communication unit 64 is an interface used for communicating with the printer 10 or the like. By controlling the communication unit 64, the billing server 60 conducts communication with the printer 10 or the like via the communication network 65.

The storage 63 stores billing management information on a plurality of printers 10 connected to the billing server 60 via the communication network 65. For example, the storage 63 stores a contract number and the number of printed sheets in association with each other for each of the printers 10 for which users have entered agreements. The billing server 60 is managed by the vendor of the printers 10.

<Agreements for Printers 10>

The user of the printer 10 may enter an agreement with the vendor of the printer 10 and use the printer 10 in accordance with the terms of this agreement. As an example, this embodiment considers a case in which the vendor of the printer 10 offers a service for a fee (i.e., a paid service) that allows the user to use ink free of charge until the number of printed sheets reaches a contracted number of sheets.

In the non-contracted state before the user has concluded an agreement for the above service, the user purchases commercial bottles (not shown) containing commercial ink and injects commercial ink into (i.e., provides commercial ink to) the tank 30 from the purchased commercial bottles. In the non-contracted state, the printer 10 normally performs printing and the like while consuming commercial ink. The vendor ships contract bottles (not shown) containing contract ink to users that have entered an agreement for the above service. The vendor ships a contract bottle when the ink in the printer 10 runs low, for example. In the contracted state after the user has entered an agreement for the above service, the user receives contract bottles shipped from the vendor and injects contract ink into (i.e., provides contract ink to) the tank 30 from the received contract bottles. In the contracted state, the printer 10 ordinarily performs printing and the like while consuming contract ink.

The controller 50 of the printer 10 is configured to switch between the non-contracted state (an example of the first state) in which no agreement for ink delivery has been concluded (i.e., in which no agreement for ink delivery is in effect), and the contracted state (an example of the second state) in which an agreement for ink delivery has been concluded (i.e., in which an agreement for ink delivery is in effect). The controller 50 is configured to execute different processes between the non-contracted state and the contracted state. The EEPROM 54 stores contract information indicating whether the current state is the non-contracted state or the contracted state (see FIG. 3). The contract information takes a first value (e.g., 0) for the non-contracted state and a second value (e.g., 1) for the contracted state. When the power to the printer 10 is turned on, the CPU 51 copies the contract information stored in the EEPROM 54 to the RAM 53. The controller 50 enters one of the non-contracted state and the contracted state in accordance with the contract information stored in the RAM 53.

Additionally, when a process to enter an agreement for the delivery of ink to the printer 10 is carried out between the terminal possessed by the user and the server of the vendor, the controller 50 may overwrite the contact information stored in the EEPROM 54 from the non-contracted state to the contracted state based on instructions from the server of the vendor. Similarly, if a process to cancel the above agreement is carried out between the user's terminal and the vendor's server, the controller 50 may overwrite the contract information stored in the EEPROM 54 from the contracted state to the non-contracted state based on instructions from the vendor's server.

<Data Used by the Controller 50>

By the CPU 51 executing a program stored in the ROM 52, the controller 50 performs the main process shown in FIG. 4, which includes a residual quantity calculation process shown in FIGS. 5 and 6. In the following description, a variable i, which takes a value between 1 and 4, is used to specify one of the four colors of ink. Values 1, 2, 3, and 4 correspond to the colors black, magenta, cyan, and yellow, respectively. Thus, the 1-th ink is black ink, and the 1-th ink chamber is the ink chamber 36B that stores black ink.

The controller 50 uses the following data in the process shown in FIGS. 4 through 6. A commercial residual quantity Ai specifies the residual quantity of i-th commercial ink injected into (provided to) the tank 30 (the quantity of ink remaining in the i-th ink chamber 36 that was originally contained in a commercial bottle). A contract residual quantity Bi specifies the residual quantity of i-th contract ink injected into (provided to) the tank 30 (the quantity of ink remaining in the i-th ink chamber 36 that was originally contained in a contract bottle). A consumption quantity Si specifies the amount of i-th ink consumed during an ink consumption process executed by the printer 10. The ink consumption process is a process that consumes ink. The commercial residual quantity Ai is an example of the first remaining life that is the remaining life of the consumable that is provided to the consumable holder during the first state (i.e., during a time when no agreement for delivery of the consumable is in effect). The contract residual quantity Bi is an example of the second remaining life that is the remaining life of the consumable that is provided to the consumable holder during the second state (i.e., during a time when an agreement for delivery of the consumable is in effect).

A maximum tank volume Ti indicates the maximum quantity of i-th ink that can be stored in the tank 30. The maximum tank volume Ti is a fixed value and is no greater than the capacity of the i-th ink chamber 36. A saved residual quantity Mi indicates the remaining quantity of i-th contract ink stored in the tank 30 at the time of cancellation of the agreement. The maximum tank volume Ti is an example of the maximum remaining life of the consumable. While the printer 10 is operating, the CPU 51 stores the above data in the RAM 53 and updates the data stored in the RAM 53 as needed. The CPU 51 copies the data in the RAM 53 to the EEPROM 54 when the power to the printer 10 is turned off and copies the data from the EEPROM 54 to the RAM 53 when the power to the printer 10 is turned on.

A replenishment flag Ei indicates whether i-th ink has been refilled (injected) between the opening and closing of the cover 13. The replenishment flag Ei is set to ON when i-th ink has been replenished between the opening and closing of the cover 13 and set to OFF when i-th ink has not been replenished between the opening and closing of the cover 13. When the user replenishes the tank 30 with ink, the user fills the tank 30 until the quantity of i-th ink stored in the tank 30 reaches the maximum tank volume Ti.

A billing flag indicates whether the billing server 60 is to execute a billing process for an ink consumption process performed by the printer 10. The billing flag is set to ON when the billing server 60 is to execute the billing process and to OFF when the billing server 60 is not to execute the billing process. A commercial flag Fi indicates whether the i-th ink consumed in an ink consumption process is all commercial ink. The commercial flag Fi is set to ON when the consumed i-th ink is all commercial ink and to OFF when the consumed i-th ink includes contract ink.

<Main Process>

Next, a main process executed by the controller 50 will be described in detail with reference to FIG. 4. In the main process shown in FIG. 4, the controller 50 repeatedly executes a process for a case of ink consumption (S12 to S16), a process for a case of ink replenishment (S23 to S28), and other processes (S29).

In 511 at the beginning of these repeated processes, the controller 50 determines whether the process to be executed is an ink consumption process. The controller 50 determines in 511 that the process to be executed is an ink consumption process when the user has inputted a print instruction through operations on the operating unit 16, for example.

When the controller 50 determines that the process to be executed is an ink consumption process (511: YES), in S12 the controller 50 executes the ink consumption process. Examples of the ink consumption process executed in S12 are an image recording process (printing process) for recording images on sheets, and a maintenance process for the print head 22. In S13 the controller 50 executes a residual quantity calculation process for a case of ink consumption (see FIG. 6). In the residual quantity calculation process for a case of ink consumption, the controller 50 sets the billing flag to ON or OFF.

In S14 the controller 50 determines whether the billing flag is ON. When the controller 50 determines that the billing flag is ON (S14: YES), in S15 the controller 50 notifies the billing server 60 that billing is to be conducted, i.e., that a billable ink consumption process (i.e., the ink consumption process for which billing is to be conducted) has been performed. In 515 the controller 50 controls the communication unit 57 to transmit billing information to the billing server 60. The billing information includes the contract number, the number of printed sheets, and the residual quantities of ink in the tank 30.

In S16 the controller 50 displays a message on the display 15 indicating that the billing has been conducted. For example, in S16 the controller 50 displays the message “You have been billed for printing 5 sheets” on the display 15. Subsequently, the controller 50 returns to 511 to execute the next process.

On the other hand, when the controller 50 determines in S14 that the billing flag is OFF (S14: NO), the controller 50 skips steps S15 and S16 and returns to S11.

Further, when the controller 50 determines in 511 that the process to be executed is not an ink consumption process (511: NO), in S21 the controller 50 determines whether the cover 13 is in the open state. When the controller 50 determines that the cover 13 is in the open state (521: YES), in S22 the controller 50 determines whether the cover 13 is in the closed state. The controller 50 continues to loop back to S22 while the cover 13 remains in the open state (S22: NO). When the controller 50 determines that the cover 13 is in the closed state (S22: YES), the controller 50 advances to S23. In this way, after the cover 13 has been placed in the open state, the controller 50 waits in S22 until the cover 13 has been returned to the closed state.

Hereafter, the controller 50 executes the necessary steps from S23 to S26 for each of the colors black, magenta, cyan, and yellow. Specifically, the controller 50 initially sets the variable i to 1 and executes steps S23 through S26. Thereafter, the controller 50 repeats steps S23 through S26 while incrementing the variable i by 1 each time. After completing step S25 or S26 while variable i is set to 4, the controller 50 advances to S27.

When beginning the process for each color, in S23 the controller 50 displays a message on the display 15 asking the user whether ink of the current color has been refilled. For example, in S23 the controller 50 displays “Has the i-th ink been refilled?” on the display 15. In other words, when the variable i is set to 1, the controller 50 displays “Has the black ink been refilled?” on the display 15. After the above message has been displayed on the display 15, the user inputs a YES or NO value into the printer 10 through operations on the operating unit 16.

In S24 the controller 50 determines whether the user's input is a YES value. When the controller 50 determines that the user's input is a YES value (S24: YES), in S25 the controller 50 sets the replenishment flag Ei to ON. When the controller 50 determines in S24 that the user's input is a NO value (S24: NO), in S26 the controller 50 sets the replenishment flag Ei to OFF. After completing the necessary steps in S23 through S26 for each color, the controller 50 advances to S27.

In S27 the controller 50 determines whether any of the replenishment flags Ei are ON, i.e., whether at least one of the replenishment flags Ei is ON. When the controller 50 determines that any of the replenishment flags Ei are ON (i.e., that at least one of the replenishment flags Ei is ON; S27: YES), in S28 the controller 50 executes the residual quantity calculation process for a case of ink replenishment. Subsequently, the controller 50 returns to S11. On the other hand, when the controller 50 determines that none of the replenishment flags Ei is ON (i.e., that all replenishment flags Ei are OFF; S27: NO), the controller 50 skips step S28 and returns to S11.

Further, when the controller 50 determines in S21 that the cover 13 is not the open state (i.e., that the cover 13 is in the closed state; S21: NO), in S29 the controller 50 executes another process (a process other than the process for a case of ink consumption and the process for a case of ink replenishment). Subsequently, the controller 50 returns to S11.

Thus, when the billing flag is ON after the controller 50 executes an ink consumption process in S12, in S15 the controller 50 executes a process for billing. In response to executing the process for billing, in S16 the controller 50 executes a process to display a message on the display 15 indicating that billing has been conducted, i.e., that the user has been billed for the ink consumption process.

<Residual Quantity Calculation Process>

Next, the residual quantity calculation process executed by the controller 50 will be described in detail with reference to FIGS. 5 and 6. The residual quantity calculation process is called from steps S13 and S28 shown in FIG. 4. In S31 at the beginning of the residual quantity calculation process, the controller 50 determines whether the current residual quantity calculation process (i.e., the residual quantity calculation process to be executed) is the residual quantity calculation process for a case of ink replenishment. Here, when the process has been called from step S28, the controller 50 determines in S31 that the process is the residual quantity calculation process for a case of ink replenishment. On the other hand, when the process has been called from step S13, the controller 50 determines in S31 that the process is not the residual quantity calculation process for a case of ink replenishment (i.e., that the process is the residual quantity calculation process for a case of ink consumption).

The controller 50 advances to S32 when determining that the current residual quantity calculation process is the residual quantity calculation process for a case of ink replenishment (S31: YES). In this case, the controller 50 executes the necessary steps among S32 through S37 and S41 through S46 for each of the colors black, magenta, cyan, and yellow. Specifically, the controller 50 initially sets the variable i to 1 and executes steps S32 through S37 and S41 through S46. Subsequently, the controller 50 repeatedly executes the process in S32 through S37 and S41 through S46 while incrementing variable i by 1 each time. The controller 50 returns to S11 in FIG. 4 when reaching a NO determination in S32 or after completing one of S37, S42, and S46 while variable i is set to 4.

When beginning this process for each color, in S32 the controller 50 determines whether the corresponding replenishment flag Ei is ON. When the controller 50 determines that the replenishment flag Ei is not ON (i.e., that the replenishment flag Ei is OFF; S32: NO), the controller 50 skips steps S33 through S37 and S41 through S46 for this color. Thus, in the residual quantity calculation process, the controller 50 does not execute a process related to the i-th ink when the i-th ink has not been refilled.

However, when the controller 50 determines in S32 that the replenishment flag Ei is ON (S32: YES), in S33 the controller 50 determines whether the controller 50 is in a contracted state. The controller 50 makes this determination in S33 based on the contract information stored in the RAM 53. When the controller 50 determines that the controller 50 is not in a contracted state (i.e., that the controller 50 is in a non-contracted state; S33: NO), in S34 the controller 50 determines whether the contract residual quantity Bi is greater than 0.

When the controller 50 determines that the contract residual quantity Bi is greater than 0 (S34: YES), the controller 50 advances to S35. That is, the controller 50 advances to S35 when the tank 30 is refilled with the i-th ink during the non-contracted state while i-th contract ink is still remaining in the tank 30. In this case, in S35 the controller 50 displays a message on the display 15 indicating that some contract ink remains in the tank 30. For example, in S35 the controller 50 displays “The tank still contains i-th contract ink. The current residual quantity of this contract ink will be deducted from the residual quantity of i-th commercial ink when a next agreement is entered.” In S36 the controller 50 sets the saved residual quantity Mi to this contract residual quantity Bi. In S37 the controller 50 sets the commercial residual quantity Ai to the maximum tank volume Ti and resets the contract residual quantity Bi to 0.

On the other hand, when the controller 50 determines in S34 that the contract residual quantity Bi is not greater than 0 (i.e., that the contract residual quantity Bi is 0; S34: NO), the controller 50 skips steps S35 and S36 and advances directly to S37. In S37 the controller 50 performs the same process described above.

Thus, when the i-th ink has been replenished in the non-contracted state, the controller 50 deems that the tank 30 has been refilled with i-th commercial ink up to the maximum tank volume Ti. Accordingly, the controller 50 sets the commercial residual quantity Ai to the maximum tank volume Ti and resets the contract residual quantity Bi to 0. Further, when i-th contract ink remains in the tank 30, the controller 50 stores the quantity of remaining contract ink (the contract residual quantity Bi) in the storage as the saved residual quantity Mi.

On the other hand, when the controller 50 determines in S33 that the controller 50 is in the contracted state (S33: YES), the controller 50 advances to S41. In this case, the controller 50 executes the necessary steps in S41 through S46 for the current color of ink.

At the start of the process for the current color, in S41 the controller 50 determines whether the commercial residual quantity Ai is 0. When the controller 50 determines that the commercial residual quantity Ai is 0 (S41: YES), in S42 the controller 50 sets the contract residual quantity Bi to the maximum tank volume Ti.

However, when the controller 50 determines that the commercial residual quantity Ai is not 0 (S41: NO), in S43 the controller 50 determines whether the commercial residual quantity Ai is greater than or equal to the saved residual quantity Mi. When the controller 50 determines that the commercial residual quantity Ai is greater than or equal to the saved residual quantity Mi (S43: YES), in S44 the controller 50 subtracts the saved residual quantity Mi from the commercial residual quantity Ai and subsequently sets the saved residual quantity Mi to 0. In other words, in S44 the controller 50 calculates the result of subtracting the saved residual quantity Mi from the commercial residual quantity Ai, sets the commercial residual quantity Ai to the subtraction result, and sets the saved residual quantity Mi to 0. In S46 the controller 50 sets the contract residual quantity Bi to (the maximum tank volume Ti—the commercial residual quantity Ai), i.e., to a value obtained by subtracting the commercial residual quantity Ai from the maximum tank volume Ti. In other words, in S46 the controller 50 calculates the result of subtracting the commercial residual quantity Ai from the maximum tank volume Ti, and sets the contract residual quantity Bi to the subtraction result.

However, when the controller 50 determines in S43 that the commercial residual quantity Ai is not greater than or equal to the saved residual quantity Mi (i.e., that the commercial residual quantity Ai is less than the saved residual quantity Mi; S43: NO), in S45 the controller 50 subtracts the commercial residual quantity Ai from the saved residual quantity Mi and sets the commercial residual quantity Ai to 0. In other word, in S45 the controller 50 calculates the result of subtracting the commercial residual quantity Ai from the saved residual quantity Mi, sets the saved residual quantity Mi to the subtraction result, and sets the commercial residual quantity Ai to 0. Subsequently, the controller 50 advances to S46 and executes the process described above. After executing the required steps in S32 through S37 and S41 through S46 for each color, the controller 50 ends the residual quantity calculation process.

Thus, when the i-th ink has been replenished in the contracted state, the controller 50 assumes that the tank 30 has been refilled with i-th contract ink up to the maximum tank volume Ti and sets the contract residual quantity Bi to the maximum amount of the i-th ink that can be stored in the tank 30. The maximum amount of i-th ink that can be stored in the tank 30 is the maximum tank volume Ti when no i-th commercial ink remains in the tank 30 and is a value obtained by subtracting the commercial residual quantity Ai from the maximum tank volume Ti (i.e., the maximum tank volume Ti−the commercial residual quantity Ai) when i-th commercial ink remains in the tank 30.

As the user has been notified in S35 described above, the controller 50 also performs a process to deduct the residual quantity of i-th contract ink at the timing of S35 from the residual quantity of i-th commercial ink. Specifically, in S44 the controller 50 subtracts the saved residual quantity Mi from the commercial residual quantity Ai and resets the saved residual quantity Mi to 0. However, since the saved residual quantity Mi cannot be subtracted from the commercial residual quantity Ai when the commercial residual quantity Ai is less than the saved residual quantity Mi, in S45 the controller 50 subtracts the commercial residual quantity Ai from the saved residual quantity Mi and then resets the commercial residual quantity Ai to 0.

On the other hand, when the controller 50 determines in S31 that the process to be executed is not the residual quantity calculation process for a case of ink replenishment (i.e., that the process is the residual quantity calculation process for a case of ink consumption; S31: NO), in S51 of FIG. 6 the controller 50 determines whether the controller 50 is in a contracted state. When the controller 50 determines that the controller 50 is in a contracted state (S51: YES), the controller 50 advances to S52. In this case, the controller 50 executes the necessary steps from S52 to S56 for each of the colors black, magenta, cyan, and yellow. Specifically, the controller 50 initially sets the variable i to 1 and executes S52 through S56. Subsequently, the controller 50 repeats the process from S52 through S56 while incrementing the variable i by 1 each time. After executing step S54 or S56 while the variable i is set to 4, the controller 50 advances to S61.

When beginning the above process for each color, in S52 the controller 50 determines whether the commercial residual quantity Ai is greater than or equal to the consumption quantity Si. When the controller 50 determines that the commercial residual quantity Ai is greater than or equal to the consumption quantity Si (S52: YES), in S53 the controller 50 subtracts the consumption quantity Si from the commercial residual quantity Ai. In other word, in S53 the controller 50 calculates the result of subtracting the consumption quantity Si from the commercial residual quantity Ai and sets the commercial residual quantity Ai to the subtraction result. In S54 the controller 50 sets the commercial flag Fi to ON.

However, when the controller 50 determines in S52 that the commercial residual quantity Ai is not greater than or equal to the consumption quantity Si (i.e., that the commercial residual quantity Ai is less than the consumption quantity Si; S52: NO), in S55 the controller 50 subtracts a value obtained by subtracting the commercial residual quantity Ai from the consumption quantity Si (i.e., the consumption quantity Si—the commercial residual quantity Ai) from the contract residual quantity Bi and resets the commercial residual quantity Ai to 0. In other words, in S55 the controller 50 calculates the result of subtracting the commercial residual quantity Ai from the consumption quantity Si, computes the result of subtracting the calculated subtraction result from the contract residual quantity Bi, sets the contract residual quantity Bi to the final subtraction result, and resets the commercial residual quantity Ai to 0. In S56 the controller 50 sets the commercial flag Fi to OFF. After executing the required steps in S52 to S56 for each color, the controller 50 advances to S61.

In this way, the controller 50 performs a process to prioritize the decreasing of commercial ink when ink has been consumed in the contracted state. Specifically, when the commercial residual quantity Ai is greater than or equal to the consumption quantity Si, the controller 50 considers that only commercial ink has been consumed and subtracts the consumption quantity Si from the commercial residual quantity Ai in S53. However, when the commercial residual quantity Ai is less than the consumption quantity Si, the controller 50 considers that all commercial ink has been consumed and that contract ink has been consumed to make up the difference. Thus, in S55 the controller 50 subtracts a value obtained by subtracting the commercial residual quantity Ai from the consumption quantity Si (i.e., the consumption quantity Si−commercial residual quantity Ai) from the contract residual quantity Bi and sets the commercial residual quantity Ai to 0.

In S61 the controller 50 determines whether the executed ink consumption process is a billable ink consumption process (e.g., a billable printing process). That is, the ink consumption processes (i.e., the types of ink consumption processes) include billable ink consumption processes (i.e., the ink consumption processes for which billing is to be conducted) and non-billable ink consumption processes (i.e., the ink consumption processes for which billing is not to be conducted). For example, in S61 the controller 50 determines that ink recording processes (printing processes) and other processes instructed to be executed by the user are billable ink consumption processes and determines that maintenance processes performed for the print head 22, test printing processes for maintenance, and the like are non-billable ink consumption processes.

When the controller 50 determines that the executed ink consumption process is a billable ink consumption process (S61: YES), in S62 the controller 50 determines whether all commercial flags Fi are ON. When the controller 50 determines that any of the commercial flags Fi are not ON (i.e., that at least one of the commercial flags Fi is OFF; S62: NO), in S63 the controller 50 sets the billing flag to ON.

On the other hand, when the controller 50 determines in S61 that the executed ink consumption process is not a billable ink consumption process (S61: NO) or determines in S62 that all commercial flags Fi are ON (S62: YES), in S64 the controller 50 sets the billing flag to OFF.

Further, when the controller 50 determines in S51 that the controller 50 is not in a contracted state (i.e., that the controller 50 is in a non-contracted state; S51: NO), in S65 the controller 50 subtracts the consumption quantity Si from the commercial residual quantity Ai for each of the colors black, magenta, cyan, and yellow. In other words, in S65 the controller 50 calculates the result of subtracting the consumption quantity Si from the commercial residual quantity Ai and sets the commercial residual quantity Ai to the subtraction result for each of the colors black, magenta, cyan, and yellow. In S66 the controller 50 sets the billing flag to OFF. After executing one of steps S63, S64, and S66, the controller 50 ends the residual quantity calculation process.

In this way, the controller 50 sets the commercial flag Fi to ON in S54 when the commercial ink has not run out during the current ink consumption process (when the commercial residual quantity Ai is greater than or equal to the consumption quantity Si) and sets the commercial flag Fi to OFF in S56 when the commercial ink has run out during the current ink consumption process. When the executed ink consumption process is not a billable ink consumption process or when all commercial flags Fi are ON, the controller 50 sets the billing flag to OFF in S64 and does not execute the process for billing the user in S15. When the executed ink consumption process is a billable process and at least one of the commercial flags Fi is OFF, the controller 50 sets the billing flag to ON in S63 and executes the process for billing the user in S15.

In the present embodiment, the controller 50 sets the commercial flag Fi to ON when the commercial residual quantity Ai is greater than or equal to the consumption quantity Si and sets the commercial flag Fi to OFF when the commercial residual quantity Ai is less than the consumption quantity Si. As an alternative, the controller 50 may set the commercial flag Fi to ON when the commercial residual quantity Ai is greater than or equal to a value obtained by adding α to the consumption quantity Si (i.e., the consumption quantity Si+α) and may set the commercial flag Fi to OFF when the commercial residual quantity Ai is less than the value obtained by adding α to the consumption quantity Si (i.e., the consumption quantity Si+α), where α is a positive value.

<Operations of the Billing Server 60>

As described above, the controller 50 of the printer 10 transmits billing information to the billing server 60 in S15 of FIG. 4. The billing information includes a contract number, the number of printed sheets, the residual quantities of ink in the tank 30 and other information. The billing information may also include information on the printing date and time and the size and type of sheets.

When the CPU 61 of the billing server 60 receives the billing information from the printer 10 via the communication unit 64 (see FIG. 3), the CPU 61 acquires the contract number from this billing information. The CPU 61 adds a value equivalent to the number of printed sheets included in the received billing information to the number of printed sheets corresponding to the acquired contract number among the numbers of printed sheets stored in the storage 63. In this way, the CPU 61 calculates the number of printed sheets for the printer 10 for which an agreement has been concluded with the user. The administrator of the billing server 60 requests the user of the printer 10 to pay an amount based on the number of sheets printed during a predetermined period (e.g., one month). If the number of sheets printed during the predetermined period exceeds the contracted number of sheets, the billing server 60 requests the user of the printer 10 to pay an amount equivalent to the number of printed sheets that exceeds the contracted number in addition to the amount for the contracted number of sheets.

Note that the billing information that the printer 10 transmits to the billing server 60 is an instruction that triggers the billing server 60 to execute a billing process. The billing server 60 need not necessarily bill the user of the printer 10 when billing information is received but may simply perform some billing-related process (some process related to billing) for the user of the printer 10.

<Processes Executed by the Controller 50>

In the above description, steps S37, S44, S45, S53, S55, and S65 are examples of the first determination process to determine the first remaining life that is the remaining life of a consumable that is provided to the consumable holder during the first state (during a time when no agreement for delivery of the consumable is in effect). Step S12 is an example of the consumption process to perform a prescribed operation while consuming the consumable during the second state. Step S15 is an example of the bill-related process that is a process related to billing. Steps S14, S15, S52, S54, S56, and S61 through S64 are examples of the billing control process in which the controller performs the billing-related process after the first remaining life is decreased to a predetermined quantity through execution of the consumption process but does not perform the billing-related process until the first remaining life is decreased to the predetermined quantity.

Steps S37, S42, S44 through S46, and S55 are examples of the second determination process to determine the second remaining life that is the remaining life of a consumable that is provided to the consumable holder during the second state (i.e., during a time when an agreement for delivery of the consumable is in effect). Step S36 is an example of the storage process to store the second remaining life in the storage. Step S36 is executed in response to ink being injected into (provided to) the tank 30 during the non-contracted state (e.g., in response to the tank 30 being refilled with ink during the non-contracted state). Ink being injected into the tank 30 during the non-contracted state is an example of the consumable that is provided to the consumable holder during the first state (i.e., during a time when no agreement for delivery of the consumable is in effect). Steps S43, S44, and S45 are examples of the correction process to correct the first remaining life on the basis of the second remaining life stored in the storage. The correction process is executed in response to ink being injected into the tank 30 during the contracted state (e.g., in response to the tank 30 being refilled with ink during the contracted state). Ink being injected into the tank 30 during the contracted state is an example of the consumable that is provided to the consumable holder during the second state (i.e., during a time when an agreement for delivery of the consumable is in effect). S16 is an example of the notification process to control the user interface to notify that billing has been conducted. The notification process is executed in response to executing the process in S15 (an example of performing the billing-related process in the billing control process).

### Effects of the Embodiment

As described above, the printer 10 according to the present embodiment includes the tank 30 to which ink can be provided, and the controller 50. The controller 50 is switchable between the non-contracted state in which no agreement for ink delivery is in effect, and the contracted state in which an agreement for ink delivery is in effect. The controller 50 executes the first determination process (S37, S44, S45, S53, S55, and S65) to determine the commercial residual quantity, which is the residual quantity of ink provided to (injected into) the tank 30 during the non-contracted state; the consumption process (S12) to perform a printing operation while consuming ink in the contracted state; and the billing control process (S14, S15, S52, S54, S56, and S61 through S64) in which the controller 50 performs the billing-related process (S15) after the commercial residual quantity has decreased to a predetermined quantity (has run out) through execution of the consumption process but does not perform the billing-related process until the commercial residual quantity has degreased to the predetermined quantity (has run out).

In a case where a user enters an agreement for ink delivery, the printer 10 does not execute a process for billing the user until the residual quantity of ink provided to the tank 30 prior to the agreement has decreased to a predetermined quantity through ink consumption processes performed after the agreement has been concluded. Therefore, this configuration can suppress the user from incurring billing-related financial loss after entering an agreement for ink delivery.

Further, the tank 30 can hold ink of a plurality of colors. In other words, a plurality of colors of ink can be provided to the tank 30. In the billing control process, the controller 50 executes the billing-related process after the commercial residual quantity of at least one of the plurality of colors of ink has decreased to the predetermined quantity (S62: NO). Therefore, when the printer 10 has a configuration in which ink in a plurality of colors can be provided to the tank 30, the user can be suppressed from incurring billing-related financial loss after the user has concluded an agreement for ink delivery.

Further, types of the ink consumption process include the billable ink consumption process (i.e., the ink consumption process for which billing is to be conducted) and the non-billable ink consumption process (i.e., the ink consumption process for which billing is not to be conducted). In the billing control process, the controller 50 executes the billing-related process after the billable ink consumption process is performed (i.e., the executed ink consumption process is a billable ink consumption process) and the commercial residual quantity has decreased to the predetermined quantity (S61: YES and S62: NO). Therefore, when there exist both billable and non-billable ink consumption processes, this configuration can suppress the user from incurring billing-related financial loss after entering an agreement for ink delivery.

The controller 50 further executes the second determination process (S37, S42, S44 through S46, and S55) to determine the contract residual quantity, which is the residual quantity of ink provided to (injected into) the tank 30 during the contracted state. By determining the contract residual quantity in addition to the commercial residual quantity in this way, the controller 50 can reference the contract residual quantity to determine a suitable timing for starting billing.

In the second determination process (S46) executed after ink is provided to (injected into) the tank 30 during the contracted state, the controller 50 sets the contract residual quantity to the difference between the maximum tank volume, which is the maximum remaining life (amount) of ink, and the commercial residual quantity. By determining the contract residual quantity on the basis of the commercial residual quantity and in response to ink being provided to the tank 30 after the user has entered an agreement, the controller 50 can determine the contract residual quantity accurately.

Further, in both the first and second determination processes executed following the execution of the consumption process (S53 and S55), the controller 50 prioritizes decreasing the commercial residual quantity over decreasing the contract residual quantity. By giving priority to decreasing the commercial residual quantity in this way when ink is consumed, the commercial ink provided to (injected into) the tank 30 prior to the agreement being entered is treated as being consumed with priority over the contract ink in an ink consumption process, thereby enabling billing to begin earlier.

The controller 50 also includes has a storage. Further, in response to ink being provided to (injected into) the tank 30 during the non-contracted state (S33: NO), the controller 50 performs a storage process (S36) to store the contract residual quantity Bi in the storage. Furthermore, in response to ink being provided to (injected into) the tank 30 during the contracted state (S33: YES) and prior to executing the second determination process (S46), the controller 50 performs the correction process (S43 to S45) to correct the commercial residual quantity on the basis of the contract residual quantity stored in the storage. Thus, by storing the contract residual quantity when ink is provided to the tank 30 during the non-contracted state and by correcting the commercial residual quantity on the basis of the stored contract residual quantity when ink is provided to the tank 30 during the contracted state, the controller 50 can set an appropriate start timing for billing by referencing the contract residual quantity at the time of the cancellation of an agreement.

The printer 10 further includes the display 15. Further, in response to the billing-related process being executed in the billing control process (i.e., in response to the process of S15 being executed), in S16 the controller 50 executes a notification process to control the display 15 to display thereon a notification indicating that billing has been conducted. Therefore, the user can recognize through the display on the display 15 that the user has been billed.

The printer 10 further includes a printing engine that includes the carriage 21, the print head 22, and the like. The consumable is a printing agent. The consumable holder is the tank 30 having the inlet port 37 and configured to hold the printing agent provided to (injected into) the tank 30 through the inlet port 37. In the first determination process, the controller 50 determine, as the commercial residual quantity (the first remaining life), the residual quantity of the printing agent provided to (injected into) the tank 30 in the non-contracted state. In a consumption process, the controller 50 controls the printing engine to perform a printing operation while consuming the printing agent stored (held) in the tank 30. In the billing control process, the controller 50 executes the billing-related process after the residual quantity of the printing agent has decreased to a predetermined quantity through execution of the consumption process but does not execute the billing-related process until the residual quantity of the printing agent has decreased to the predetermined quantity.

Hence, when the consumable consuming device is an ink tank type printer including a printing engine and a tank having an inlet port for providing a printing agent to the tank, the user can be suppressed from incurring billing-related financial loss after entering an agreement for the delivery of the printing agent.

The program stored in the ROM 52, when executed by the CPU 51, causes the printer 10 to execute the first determination process, the consumption process, and the billing control process described above. This program is an example of the set of computer-readable instructions. The ROM 52 is an example of the non-transitory computer-readable storage medium. Therefore, when the user enters an agreement for ink delivery, this program prohibits the consumable consuming device from executing a process for billing the user until the residual quantity of ink that is provided to the tank prior to the agreement being entered falls to a predetermined quantity through consumption processes executed after the agreement is entered. Therefore, the program can suppress the user from incurring billing-related financial loss after entering an agreement for ink delivery.

### Variations of the Embodiment

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The printer 10 according to the embodiment described above can be modified in various ways. For example, while the controller 50 of the printer 10 in the above embodiment executes a plurality of steps in a predetermined order, the steps may be executed in a different order, provided that the obtained results are similar. For example, the controller 50 may execute steps S15 and S16 in FIG. 4 in reverse order, may execute steps S35 and S36 in FIG. 5 in reverse order, or may execute steps S53 and S54 in FIG. 6 in reverse order.

Further, in the printer 10 of the embodiment, the controller 50 displays a message on the display 15 in S23 asking the user whether ink was replenished and determines in S24 whether ink was replenished based on user input via the operating unit 16. However, as an alternative, the controller 50 may determine that the user replenished ink when the output signal from the cover sensor 56 has changed from a level indicating that the cover 13 is in the open state to a level indicating that the cover 13 is in the closed state due to opening and closing of the cover 13. Alternatively, the tank 30 may include an ink sensor, and the controller 50 may determine that the user replenished ink when the output signal of the ink sensor has changed from a level indicating that ink is not detected to a level indicating that ink is detected.

In the present embodiment, the printing engine of the printer 10 includes the carriage 21, feeding roller 26, conveying rollers 27, and discharging rollers 28. In a variation, the printing engine of the printer may include elements other than the above elements. Further, the printing engine of a variation need not necessarily include the carriage 21 and may exclude any of the feeding roller 26, conveying rollers 27, and discharging rollers 28.

Further, the consumables in the printer 10 of the embodiment are ink. As a variation of the printer, the consumables may be toner, paper, sheets, various rollers (developing rollers, fixing rollers, conveying rollers, etc.), photosensitive drums, cartridges, transfer belts, and print heads, for example. The printing agent may also be toner, for example. In other words, a consumable, as that term is used herein, may encompass at least: ink, toner, a sheet or other media on which printing may occur, a developing roller, a fixing roller, a conveying roller, a photosensitive drum, a cartridge, a transfer belt, or a print head. Other replaceable components of an image recording apparatus (e.g., a printer) that may be consumed (e.g., used or worn) by repetitive printing operations may be referred to as a consumable in accordance with this disclosure.

The controller of a printer according to a variation of the embodiment may perform a printing operation while consuming toner, sheets, rollers, photosensitive drums, cartridges, a transfer belt, print heads, and other consumables. When the consumable is toner, the printer includes a tank as the consumable holder to which toner can be provided (e.g., stored, injected, accommodated, or the like). When the consumable are sheets, the printer includes a feeding tray as the consumable holder to which sheets can be provided (stored, accommodated, supplied, or the like). When the consumable is a roller, the printer includes a roller mounting portion (e.g., a roller holder, a roller frame, a main body frame, or the like) as the consumable holder to which the roller can be provided (e.g., mounted, attached, installed, or the like). When the consumable is a photosensitive drum, the printer includes a drum mounting portion (e.g., a drum holder, a drum frame, a main body frame, or the like) as the consumable holder to which the photosensitive drum can be provided (e.g., mounted, attached, installed, or the like). When the consumable is a cartridge, the printer includes a cartridge mounting portion (e.g., a cartridge holder, a drawer, a main body frame, or the like) as the consumable holder to which the cartridge can be provided (e.g., mounted, attached, installed, or the like). When the consumable is a transfer belt, the printer includes a belt mounting portion (e.g., a belt holder, a main body frame, or the like) as the consumable holder to which the transfer belt can be provided (e.g., mounted, attached, installed, or the like). When the consumable is a print head, the printer includes a print head mounting portion (e.g., a carriage) as the consumable holder to which the print head can be provided (e.g., mounted, attached, installed, or the like). The carriage 21 is an example of the print head mounting portion.

The user of a printer may enter an agreement with the printer vendor for the delivery of consumables other than ink and may use the printer in accordance with the terms of this agreement. The printer vendor offers a paid service (i.e., a service for a fee) that allows the user to use toner, paper, sheets, rollers, photosensitive drums, cartridges, transfer belts, print heads, or other consumables free of charge until the number of printed sheets reaches a contracted number of sheets.

If the consumable is a roller, for example, the user purchases a commercial roller in the non-contracted state and mounts the purchased commercial roller in a roller mounting portion of the printer. In the non-contracted state, the printer normally performs printing and other processes while consuming the commercial roller. The vendor delivers a contract roller to the user who have entered an agreement for this service. In this contracted state, the user receives a contract roller shipped from the vendor and mounts the received contract roller on the roller mounting portion of the printer. In the contracted state, the printer normally performs printing and other processes while consuming the contract roller. Here, the consuming of a roller denotes the wearing down of the area of the roller that contact the paper, for example.

A printer that uses a roller as a consumable may be configured similarly to the printer 10 in the above embodiment. Printers that use toner, paper, sheets, photosensitive drums, cartridges, transfer belts, print heads, and the like as consumables may be similarly configured. A consumable consuming device other than a printer that consumes consumables can be similarly configured.

What is claimed is:

1. A consumable consuming device comprising:
a consumable holder; and
a controller switchable between a first state in which no agreement for delivery of a consumable is in effect and a second state in which an agreement for delivery of the consumable is in effect,
the controller being configured to perform:
a first determination process to determine a first remaining life, the first remaining life being a remaining life of the consumable that is provided to the consumable holder during a time when no agreement for delivery of the consumable is in effect;
a consumption process to perform a prescribed operation while consuming the consumable in the second state; and
a billing control process in which the controller performs a billing-related process after the first remaining life is decreased to a predetermined quantity through execution of the consumption process but does not perform the billing-related process until the first remaining life is decreased to the predetermined quantity.

2. The consumable consuming device according to claim 1,
wherein a plurality of consumables can be provided to the consumable holder,
wherein, in the first determination process, the controller determines the first remaining life for each of the plurality of consumables, and
wherein, in the billing control process, the billing-related process is performed after the first remaining life of at least one of the plurality of consumables is decreased to the predetermined quantity.

3. The consumable consuming device according to claim 1,
wherein types of the consumption process include the consumption process for which billing is to be conducted and the consumption process for which billing is not to be conducted, and
wherein, in the billing control process, the billing-related process is performed after the consumption process for which billing is to be conducted is performed and the first remaining life is decreased to the predetermined quantity.

4. The consumable consuming device according to claim 1,
wherein the controller is configured to further perform:
a second determination process to determine a second remaining life, the second remaining life being a remaining life of the consumable that is provided to the consumable holder during a time when an agreement for delivery of the consumable is in effect.

5. The consumable consuming device according to claim 4,
wherein, in the second determination process performed after the consumable is provided to the consumable holder during a time when an agreement for delivery of the consumable is in effect, the controller determines, as the second remaining life, a difference between a maximum remaining life of the consumable and the first remaining life.

6. The consumable consuming device according to claim 4,
wherein, both in the first determination process performed after the consumption process is performed and in the second determination process performed after the consumption process is performed, the controller prioritizes decreasing the first remaining life over decreasing the second remaining life.

7. The consumable consuming device according to claim 5,
wherein the controller includes a storage, and
wherein the controller is configured to further perform:
in response to the consumable being provided to the consumable holder during a time when no agreement for delivery of the consumable is in effect, a storage process to store the second remaining life in the storage; and
in response to the consumable being provided to the consumable holder during a time when an agreement for delivery of the consumable is in effect and prior to performing the second determination process, a correction process to correct the first remaining life on the basis of the second remaining life stored in the storage.

8. The consumable consuming device according to claim 1, further comprising a user interface,
wherein the controller is configured to perform:
in response to performing the billing-related process in the billing control process, a notification process to control the user interface to notify that billing has been conducted.

9. The consumable consuming device according to claim 1, further comprising a printing engine,
wherein the consumable is a printing agent,
wherein the consumable holder is a tank including an inlet port, the tank configured to store the printing agent injected thereinto through the inlet port,
wherein the first remaining life is a remaining amount of the printing agent injected into the tank during a time when no agreement for delivery of the consumable is in effect, and
wherein the prescribed operation is a printing operation in which the controller controls the printing engine to perform printing while consuming the printing agent stored in the tank.

10. A non-transitory computer-readable storage medium storing a set of computer-readable instructions for a consumable consuming device, the consumable consuming device including a consumable holder and a controller switchable between a first state in which no agreement for delivery of the consumable is in effect and a second state in which an agreement for delivery of the consumable is in effect,
the set of computer-readable instructions, when executed by the controller, causing the consumable consuming device to perform:
a first determination process to determine a first remaining life, the first remaining life being a remaining life of the consumable that is provided to the consumable holder during a time when no agreement for delivery of the consumable is in effect;
a consumption process to perform a prescribed operation while consuming the consumable in the second state; and
a billing control process in which the controller performs a billing-related process after the first remaining life is decreased to a predetermined quantity through execution of the consumption process but does not perform the billing-related process until the first remaining life is decreased to the predetermined quantity.
